(19) United States
(12) Patent Application Publication
(10) Pub. No.: US 2008/0094943 A1
(43) Pub. Date: Apr. 24, 2008

(54) OPTICAL PICKUP APPARATUS AND OPTICAL DISC APPARATUS USING THE SAME

(76) Inventors: Daisuke Tomita, Yokohama (JP); Akio Yabe, Fujisawa (JP); Kazuhiro Todori, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/677,068

(22) Filed: Feb. 21, 2007

(30) Foreign Application Priority Data
Oct. 20, 2006 (JP) 2006-285670

(51) Int. Cl. G11B 11/00

(52) U.S. Cl. 369/13.53

(57) ABSTRACT

An optical pickup apparatus is equipped with a light emitting device, a first objective lens for focusing a laser beam emitted from the light emitting device onto a first optical disc, a second objective lens for focusing the laser beam emitted from the light emitting device onto a second optical disc, a light receiving device for receiving the laser beam reflected by the first or second optical disc, and an optical system for dividing the laser beam emitted from the light emitting device into a beam for the first objective lens and a beam for the second objective lens. The optical pickup apparatus is capable of performing at least either recording or reproduction on/from two kinds of information recording/reproduction media that are different from each other in thickness of substrate using a laser beam emitted from the identical light emitting device, and is small in size.

### CLAIM OF PRIORITY

The present invention claims priority from Japanese application JP 2006-285670 filed on Oct. 20, 2006, the content of which is hereby incorporated by reference into this application.

### BACKGROUND

This invention relates to a compatible optical pickup apparatus capable of performing recording and reproduction on at least two kinds of optical discs that are different in recording density, a first optical disc and a second optical disc of a different standard from that of the first optical disc.

A structure of a three-wave compatible pickup that performs recording or reproduction on Bru-ray Disc (hereinafter referred to as BD), DVD, and CD. For example, JP 2005-293775 discloses a structure of the pickup apparatus that uses a blue-violet laser of a wavelength of 407 nm for a first light source, a red laser of a wavelength of 655 nm for a second light source, and an infrared laser of a wavelength of 785 nm for a third light source. Specifically, the above pickup is configured to input fluxes of lights outputted from these light sources into a three-wavelength compatible objective lens and focuses them onto recording/reproduction surfaces of the respective information recording/reproduction media.

### SUMMARY

JP-A-2005-293775, however, does not describe a case where recording and/or reproduction is performed on, for example, High-Definition Digital Versatile Disc (hereinafter referred to as HDDVD or HD).

The present invention has its object to provide a small-sized optical pickup apparatus capable of performing at lest either of recording or reproduction using a laser beam emitted from the identical light emitting device on two kinds of information recording/reproduction media that are mutually different in thickness of substrate, and an optical disc apparatus equipped therewith.

In order to attain the object, an optical pickup apparatus according to an aspect of present invention is an optical pickup apparatus that, for example, is compatible with at least a first optical disc and a second optical disc having a recording surface or a reproduction surface, the second optical disc being different from the first optical disc in thickness of substrate, and is specified to have a configuration including a light emitting device, a first objective lens for focusing a laser beam emitted from the light emitting device onto the first optical disc, a second objective lens for focusing the laser beam emitted from the light emitting device onto the second optical disc, a light receiving device for receiving the laser beam reflected by the first optical disc or the second optical disc, and an optical system for dividing the laser beam emitted from the light emitting device into two beams, one of the two beams traveling to the first objective lens, and the other beam traveling to the second objective lens, the optical system including a first optical component for reflecting or transmitting the laser beam according to the direction of polarization of the laser beam and a second optical component for transmitting the laser beam having been transmitted through the first optical component. And the laser beam reflected by the first optical component is guided to the first objective lens, the laser beam reflected by the second optical component is guided to the second objective lens, the second optical component does not make contact with a mechanical component that is a fundamental constituent of the optical pickup apparatus.

### BRIEF DESCRIPTION OF THE DRAWING

FIG. 1 is an explanatory diagram of an optical system of an optical pickup of a first embodiment;

FIG. 2 is an explanatory diagram of a method for fixing a mechanical component that is a fundamental constituent of the optical pickup of a first embodiment and a triangular prism mounted on an HD-side optical system;

FIG. 3 an explanatory diagram of a method for fixing the mechanical component that is a fundamental constituent of the optical pickup of the first embodiment, the triangle prism mounted on the HD-side optical system, and a holder holding the triangular prism;

FIG. 4 is an explanatory front view of an optical system block diagram in which an optical system of DVD and CD is combined with an optical system of the optical pickup of the first embodiment to manufacture an optical system of an optical pickup that supports four kinds of optical discs of the BD, the HD, the DVD, and the CD;

FIG. 5 is an explanatory side view of the optical system block diagram in which the optical system of DVD and CD is combined with the optical system of the optical pickup of the first embodiment to manufacture the optical system of the optical pickup that supports four kinds of optical discs of the BD, the HD, the DVD, and the CD; and

FIG. 6 is a conceptual diagram of system control of an optical disc apparatus.

### DESCRIPTION OF THE PREFERRED EMBODIMENTS

Hereafter, embodiments of an optical pickup apparatus and an optical disc apparatus equipped therewith both according to present invention will be described.

### First Embodiment

A first embodiment will be described for an optical pickup that supports an optical disc drive capable of performing recording and reproduction of BD and HD.

The BD and the HD have mutually different thicknesses of substrate. Since an optical path length from a light entering plane to a recording surface or reproducing surface is different between the BD and the HD, the optical pickup apparatus according to this invention carries two objective lenses different in specification and is configured to perform recording and reproduction of the BD and the HD with the respective objective lenses.

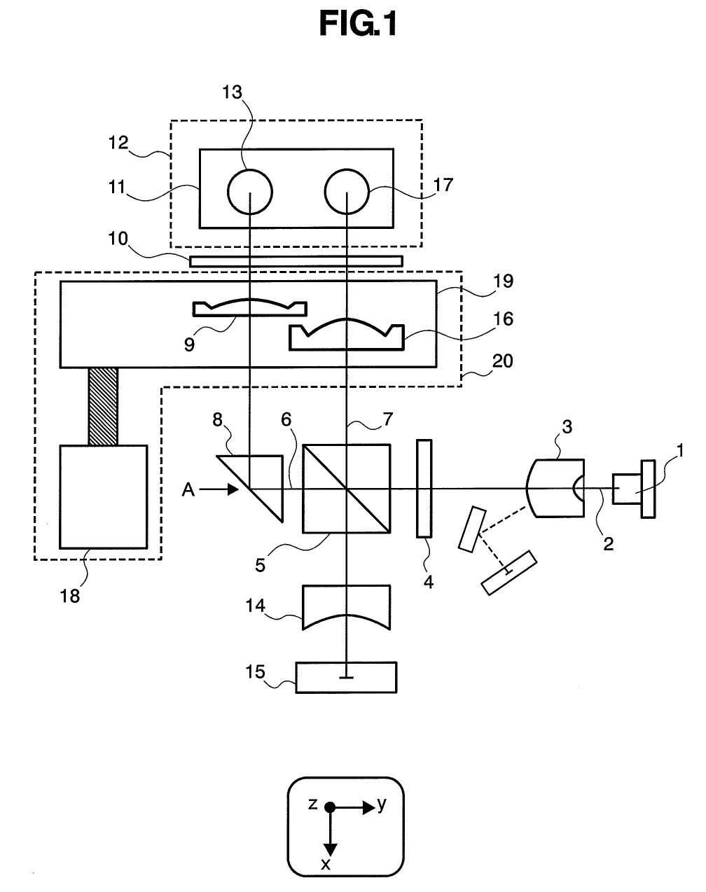

FIG. 1 is an explanatory diagram of an optical system of an optical pickup of the first embodiment. A light beam is emitted from a laser light source 1 as a divergent beam. It is general to use a semiconductor laser of a wavelength of approximately 405 nm in order to perform recording of information or reproduction of information on optical discs of the BD and the HD. It is assumed that the laser light source 1 is a semiconductor laser emitting a light beam of a wavelength of approximately 405 nm.

A light beam 2 emitted from the laser light source 1 is transmitted through a beam forming element 3 and a diffraction grating 4 equipped with a variable polarization switching element, and is divided into a light beam 6 passing through an optical system for HD and a light beam 7 passing through an optical system for BD according to the direction of polarization.

The light beam 6 is reflected by a triangular prism 8, is transmitted through a lens 9 and a quarter wavelength (λ/4) plate 10, is reflected by an erecting mirror 11 to a z-direction in the figure, and is focused by the objective lens mounted on an actuator 12 onto the optical disc (HD) (not illustrated).

The light beam 6 is reflected by the optical disc, and reaches a polarizing beam splitter 5 after passing through an objective lens 13, the erecting mirror 11, the quarter wavelength (λ/4) plate 10, the lens 9, and the triangular prism 8.

Since the light beam 6 is transmitted through the quarter wavelength (λ/4) plate 10 twice, a going way and a coming back way, the direction of polarization is rotated by 90°. Therefore it is reflected by the polarizing beam splitter 5, and is transmitted though a detection lens 14 to reach a photodetector (light receiving device) 15.

When passing through the detection lens 14, the light beam 6 is given predetermined astigmatism, which is used in detection of a focusing error signal (hereinafter referred to as FES) of an optical disc by an astigmatic method. Since the astigmatic method is a very general method for detecting the FES, its explanation will be omitted. The light beam 6 guided onto the photodetector 15 is used to detecting information signal currently recorded on the optical disc and detecting a position control signal of the optical spot focused onto the optical disc, such as TES and FES.

On the other hand, the light beam 7 is transmitted through a lens 16 and the quarter wavelength (λ) plate 10, is reflected by the erecting mirror 11 in the z-direction in the figure, and is focused onto the optical disc (BD) (not illustrated) with another objective lens 17 mounted on the actuator 12.

The light beam 7 is reflected by the optical disc, and reaches the polarizing beam splitter 5 after passing through the objective lens 17, the erecting mirror 11, the quarter wavelength (λ/4) plate 10, and the lens 16.

Like the light beam 6, since the light beam 7 is transmitted twice, on the going way and on the coming back way, through the quarter wavelength (λ/4) plate 10, the direction of polarization of the light beam rotates by 90°; therefore, the light beam 7 is transmitted through the polarizing beam splitter 5 and the detection lens 14, and reaches the photodetector 15.

Like the light beam 6, the light beam 7 also can detect a position control signal of a light spot focused onto the optical disc, such as TES and FES, and detect an information signal recorded on the optical disc with the help of the detection lens 14 and the photodetector 15.

Next, a spherical aberration compensation unit 20 will be explained. There is a specification of an optical disc that stipulates an optical disc having two layers of recording surface, called two-layer disc. When reproducing/recording such an optical disc, since the thickness from the disc surface to the recording surface is different between one of the two layers and the other, spherical aberration is produced.

The amount of this spherical aberration is dependent on NA. In the case of an optical pickup where the NA of the objective lens requires high NA like the BD, the amount of produced spherical aberration becomes not negligible, and accordingly correction means becomes essential.

The spherical aberration compensation unit 20 has a structure including the lens 16, the lens 9, a lens holder 19, and a stepping motor 18 for moving the lens holder 19 in a direction of the optical axis. The light beam entering the objective lens is converted into a focused beam or a divergent beam by moving the lens in the optical axis direction along with the lens holder with a power of a stepping motor 18. Therefore, it becomes possible to correct the spherical aberration produced in the light beam outputted from the objective lens by a difference in plate thickness between two layers of the two layer disc, which makes possible excellent recording/reproduction.

Like such an optical system, sharing a single laser light source and a single photodetector for optical discs of different standards, such as the BD and the HD, using the same recording/reproduction wavelength enables the optical structure of the optical pickup to be simplified and enables a small-spaced and inexpensive optical pickup to be manufactured.

Note that although this embodiment uses a structure in which the triangular prism guides the light beam to the objective lens of the HD, the structure is not limited to this: the triangular prism can be replaced with a mirror or a prism as long as it can guide the light beam to the objective lens with causing no trouble at all.

Moreover, although this embodiment uses a structure in which the BD-side lens 16 and the HD-side lens 9 are mounted on the lens holder 19 and they are driven in the optical axis direction by the stepping motor 18, the structure is not limited to this and a structure in which only the BD-side lens 16 is driven in the optical axis direction may also be adopted with causing no problem at all.

Furthermore, although this embodiment adopts the optical configuration as shown in FIG. 1, the configuration is not limited to this and a structure in which an optical system from the laser light source 1 to the polarizing beam splitter 5 and an optical system from the polarizing beam splitter 5 to the photodetector 15 can be interchanged each other with causing no problem. Still moreover, a pair of the BD-side objective lens 17 and the lens 16 and a pair of the HD-side objective lens 13 and the lens 9 can be interchanged with causing no problem.

Next, an adjustment method whereby two light beams returning from two optical systems of the BD and the HD are inputted into a single photodetector while intensity distributions of the two beams are aligned with each other in the optical system of the first embodiment will be described.

When adopting the optical system described in present embodiment, since ideally the light beams having passed through the respective optical systems of the BD and the HD are the light beams emitted from the identical laser light source 1, they are focused on the identical position on the photodetector 15. However, there is a case where a shift may occur in the light intensity distributions focused on the photodetector because of dispersion in mounting angles and positions of optical components of the BD and the HD and dispersion in positions of apertures each for limiting incident flux of light on the objective lens. As a result, when the general photodetector 15 is only adjusted in the x-, y-, and z-directions in the figure so that defocus may be adjusted with a signal outputted from the photodetector 15 and the light intensity distribution may be adjusted to be in the center of the photodetector 15, only adjustment based on either the optical system of the BD or that of the HD can be achieved. In other optical system that cannot be adjusted, defocusing, the FES, and the TES become factors of instability.

To circumvent this subject, this embodiment uses a configuration in which first, the light beam is adjusted to match the BD-side optical system with the photodetector 15 like the conventional method, and then the light beam is adjusted using other component in the HD-side optical system that cannot be adjusted with the photodetector 15.

Next, the adjustment in the HD-side optical system will be explained in more detail.

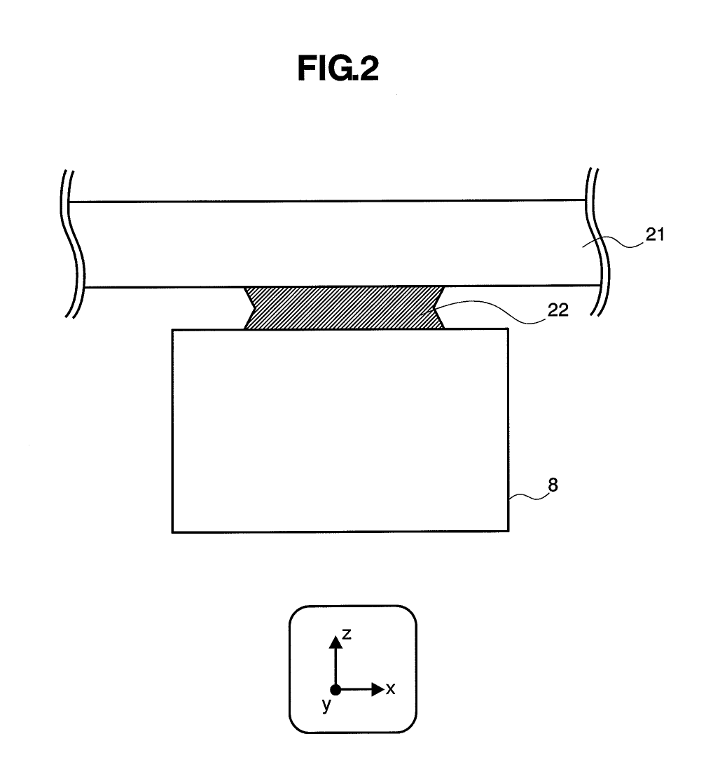

FIG. 2 is a side view of a triangular prism 8 viewed from an A-direction illustrated in FIG. 1. The optical pickup has a mechanical component (also called P case) 21 that is a fundamental constituent of the optical pickup, in which various mounted components are supported and fixed. After adjusting the triangular prism 8 mounted on the optical system on the HD-side, as shown in FIG. 2, while being floated from this mechanical component 21, an adhesive 22 is applied between the triangular prism 8 and the mechanical component 21 and cured, so that the optical pickup has a structure in which the triangular prism 8 is fixed to the mechanical component 21. Naturally, a method for fixing the triangular prism 8 may be adopted alternatively in which the triangular prim 8 and the mechanical component 21 are adjusted with the adhesive 22 intervening therebetween and subsequently the adhesive 22 is cured. As the adhesive 22, ultraviolet curable adhesives are desirable.

By adopting such a structure, the triangular prism 8 can be adjusted to have arbitrary angle and position, and an intensity distribution of the light beam of the other optical system, the HD optical system, that cannot be adjusted by adjustment of the photodetector 15, can be guided on the photodetector 15, and at the same time defocusing can be adjusted to attain optimal focusing. As a result, this adjustment method has an effect of being capable of performing stable FES and TES controls.

Moreover, regarding optical components that transmit the light beam therethrough in the same route for the going way and for the coming back way in temperature characteristic and environmental tests (a high temperature shelf test, a low temperature shelf test, a high-temperature and high humidity shelf test, a temperature cycling test), a shift of the intensity distribution that is caused by shifting of a position and an angle of the optical component shows dull sensitivity of the shifting. Therefore, the method for adjusting the triangular prism 8 that is a component having such a property, brings about an effect of being tough against a variation in temperature and a change in environment, and accordingly realizing high stability even in the case of fixing it with only an adhesive so that it may not make contact with mechanical components.

Furthermore, the amounts of intentional shifting of the angle and the position necessary for the adjustment become large because components having dull effects on the position and angle in the adjustment are adjusted, this method has an effect that fine tuning can be done without using an expensive precession adjustment controller.

Still moreover, adjusting the triangular prism by this method enables the outgoing beams for the objective lenses of the BD- and HD-optical systems to be emitted with almost the same gradient and almost in the same direction, which has an effect of reducing a relative gradient, i.e., a difference of the gradient angle of the optical disc at which excellent recording and reproduction can be performed for the BD- and HD-optical systems.

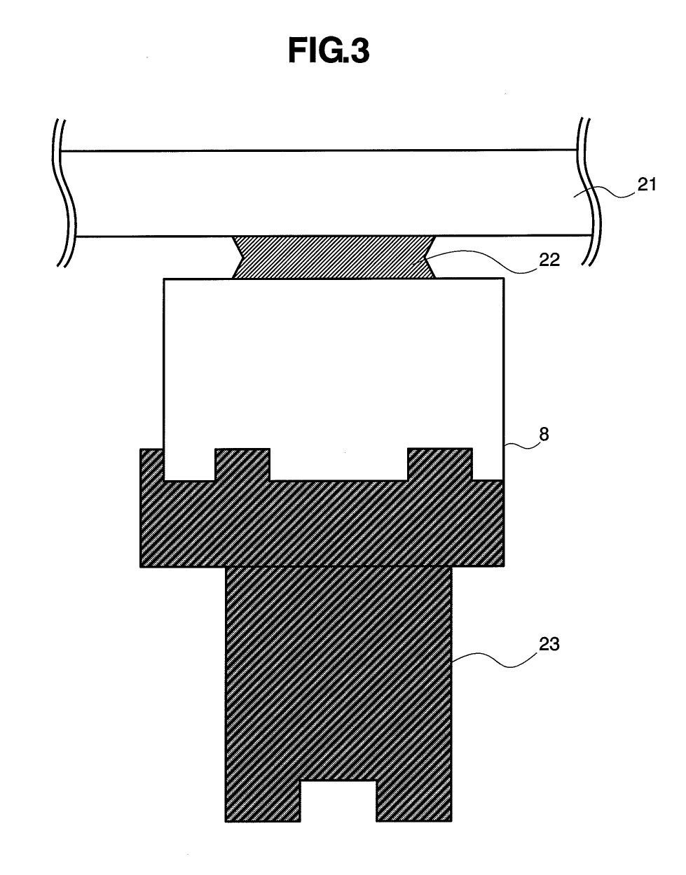

In order to adjust the position and angle of the triangular prism 8, the triangular prism 8 needs an additional region around it to that will allow the triangular prism to be seized by a tool outside the region where the fluxes of light pass through. This requires a need of enlarging the outer shape of the triangular prism 8. In this embodiment, the triangular prism 8 is equipped with a holder 23 for holding the triangular prism 8 as shown in FIG. 3. The holder 23 is provided at a position at which it does not interrupt the optical path of the laser beam. By using the holder 23 like this, the triangular prism 8 can be realized to have an optimal size. Further, this optimization of the holder 23 has an effect of reducing a cost of the triangle prism 8.

By mounting the triangular prism 8 in the holder 23 like this, it becomes possible to prevent or restrain the triangular prism 8 from being imparted or being stained with dirt at the time of adjustment of position and angle.

The shape of the holder 23 is not limited to the shape shown in FIG. 3. Any shape of the holder can be used as long as the holder can hold the triangular prism 8 and allows the triangular prism 8 to be adjusted. Moreover, the holder 23 may be fixed to the mechanical component 21 with intervening adhesive while the triangular prism 8 is held in the holder 23 and the holder 23 is being adjusted in position and angle.

Note that the embodiment has a structure in which the optical component for final adjustment of the HD optical system is adjusted by the triangular prim 8 disposed in the HD optical system. However, the structure is not limited to this. As the optical component for adjustment, all the optical components ranging from an optical component for dividing the light beam into the two optical systems (in this embodiment, the polarization beam splitter 5) to the objective lens come under this category. Therefore, the optical pickup apparatus may adopt a structure in which the erecting mirror or the lens is adjustable without allowing it to make contact with the mechanical component 21 (P case) with causing no trouble at all.

For example, the following method may be adopted: the triangular prism 8 may be fixed to the mechanical component 21 while it makes contact with the component 21, and any of the optical components arranged on the optical path between the triangular prism 8 and the objective lens 13, e.g., the lens, is adjusted as an optical component for adjustment and is fixed with an ultraviolet curable adhesive without allowing the lens to make contact with the mechanical component 21. In this case, final adjustment of the HD optical system can be done by adjusting the position of the lens.

Moreover, in the case where the lens for final adjustments is mounted on the lens holder, the following method may also be adopted: the lens holder is fixed to the mechanical component 21 by making it contact with the component 21, subsequently adjustment of the HD optical system is done by changing the position of the lens while the lens is not allowed to make contact with the lens holder, and then the lens is fixed to the lens holder with an intervening ultraviolet curable adhesive.

Alternatively, the following method may be adopted: the HD optical system is adjusted by changing the position of the lens holder while the lens is fixed making contact with the lens holder and the lens holder is held while it does not make contact with the mechanical component 21, and subsequently the lens holder is fixed to the mechanical component 21 with an intervening ultraviolet curable adhesive.

Furthermore, the both the lens holder and the lens are adjusted as the optical components for adjustment. Alternatively, the HD optical system may be adjusted by changing the position or angle between the lens holder and the lens, while the lens holder does not make contact with the mechanical components 21 and further the lens does not make contact with the lens holder. Then, what is necessary after the adjustment is to fix the lens holder to the mechanical component 21 with an ultraviolet curable adhesive and fix the lens to the lens holder with the ultraviolet curable adhesive.

In the above, the HD optical system is adjusted finally. However, the adjustment may be done such that the BD optical system is finally adjusted, conversely. In doing so, the following method may be adopted: any of the optical components constituting the BD optical system is adjusted as an optical component for final adjustment while it does not make contact with mechanical components, and this optical component for final adjustment is fixed with an ultraviolet curable adhesive.

The optical pickup apparatus manufactured according to the adjustment method described above can be used to perform stable FES-control and TES-control.

### Second Embodiment

A second Embodiment will explain an optical pickup compatible with four kinds of media of the BD, the HD, the DVD, and the CD using the optical system explained in the first embodiment.

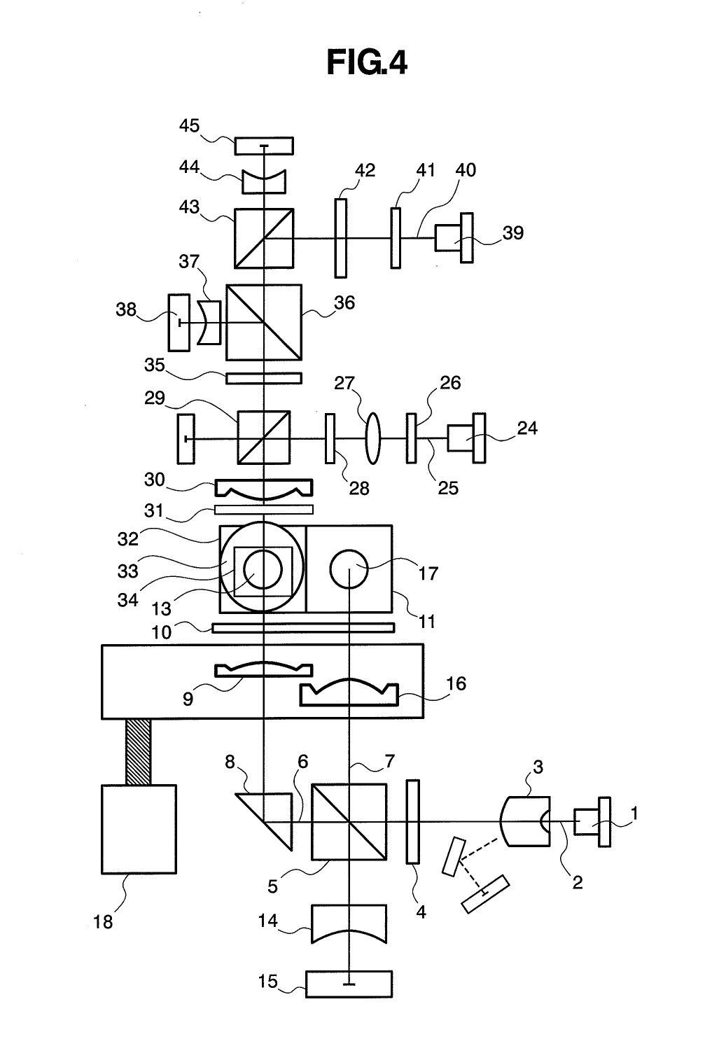

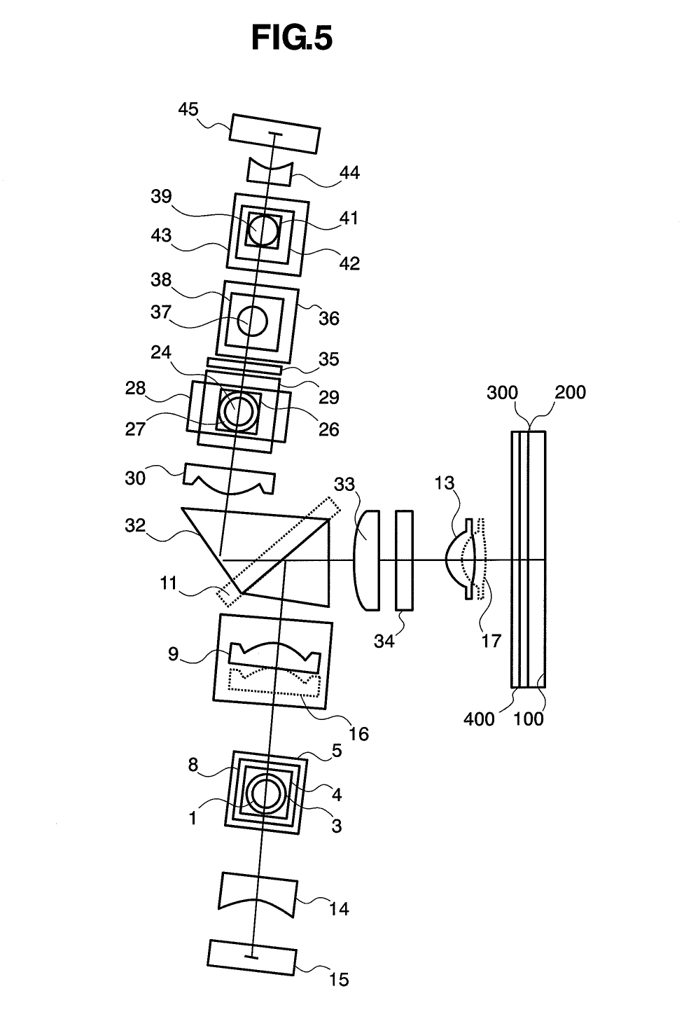

FIGS. 4 and 5 are explanatory diagrams of the optical pickup optical system that supports four kinds media of the BD, the HD, the DVD, and the CD that use the optical system of the first embodiment, in which FIG. 4 shows its front view and FIG. 5 shows its side view.

A CD beam 25 emitted from a CD laser 24 is transmitted through a half wavelength plate 26, a lens 27, and a diffraction grating 28, is reflected by a polarizing beam splitter 29, is transmitted through a lens 30 and a DVD/CD wide-band quarter wavelength plate 31, is reflected by a composite type erecting prism 32, is transmitted though a lens 33 and an aperture limiting element 34, and enters the HD/DVD/CD compatible objective lens 13. Then, it is focused onto a CD disc 100.

After reflected by the CD disc 100, the laser beam is transmitted through the HD/DVD/CD compatible objective lens 13, the aperture limiting element 34, and the lens 33, and is reflected by the composite type erecting prism 32.

Then, the laser beam is transmitted through the DVD/CD wide band quarter wavelength plate 31, the lens 30, the polarizing beam splitter 29, and a wavelength-selective half wavelength plate 35, is reflected by a polarizing beam splitter 36, is transmitted through a detection lens 37, and enters a photodetector 38.

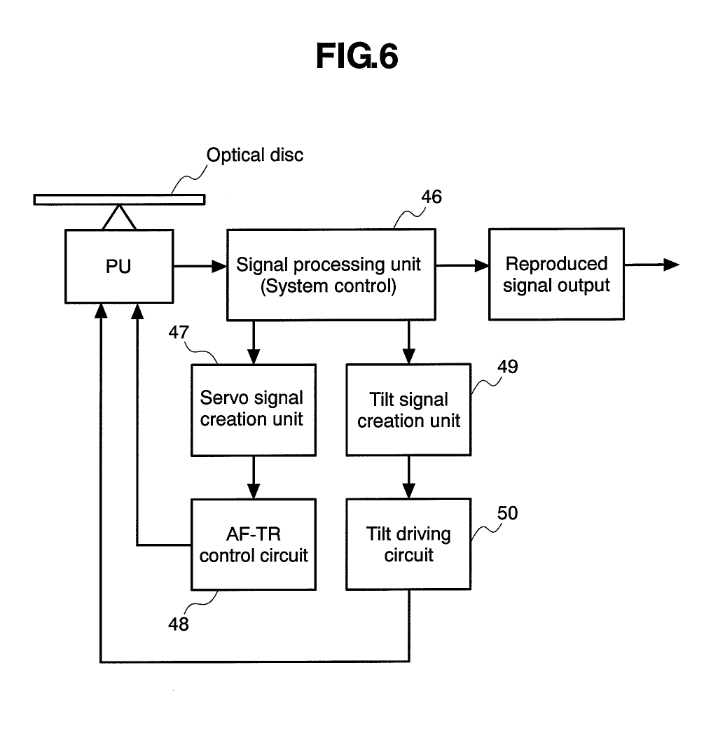

A signal processing unit 46 of the optical disc apparatus shown in FIG. 6 performs signal processing on a signal obtained by the photodetector 38 to obtain a reproduced signal at the time of reproduction. At the same time, a servo signal creation unit 47 creates signals whereby the compatible objective lens 2 is focus-controlled and tracking-controlled, inputs them into an AF-TR control circuit 48, which performs AF (Auto Focus) control and TR (TRacking) control. Moreover, a tilt driving signal is created in a tilt signal creation unit 49, and enters a tilt driving circuit 50 to generate a tilt current. The tilt current is applied to a tilt coil to make a movable part, including the HD/DVD/CD compatible objective lens 13, perform a tilt operation.

These system controls are conducted in the signal processing unit 46, controlling so as to obtain a best optical characteristic.

Although not illustrated, an objective lens driving device mounted in such a compatible optical pickup is generally a three-dimensional objective lens driving device that conducts an AF operation, a TR operation, and a TILT operation. In its movable part that houses the objective lens, an AF coil, a TR coil, and a TILT coil are arranged. This movable part is supported by six conductive elastic support members with respect to a stationary part constructed with a magnet, a yoke, etc., which makes possible the system control of the movable part.

A DVD beam 40 emitted from a DVD laser 39 is transmitted through a half-wave plate 41 and a diffraction grating 42, is reflected by a polarizing beam splitter 43, and is transmitted through the polarizing beam splitter 36, the wavelength-selective half wavelength plate 35, a polarizing beam splitter 29, the lens 30, and the DVD/CD wide band quarter wavelength plate 31. Further, it is reflected by the composite type erecting prism 32, the lens 33 and the aperture limiting element 34, and enters the HD/DVD/CD compatible objective lens 13. Then, it is focused on a DVD disc 200. After being reflected by the DVD disc 200, the beam is transmitted through the DVD/CD compatible objective lens 13, the aperture limiting element 34, and the lens 33, and is reflected by the composite type erecting prism 32.

Then, it is transmitted through the DVD/CD wide band quarter wavelength plate 31, the lens 30, the polarizing beam splitter 29, the wavelength-selective half wavelength plate 35, the polarizing beam splitter 36, the polarizing beam splitter 43, and a detection lens 44, and enters a photodetector 45.

A signal obtained with the photodetector 45 is subjected to signal processing in the signal processing unit 46 of the optical disc apparatus shown in FIG. 6 like the signal obtained with the photodetector 38 for CD described above. The system control of recording/reproduction of the DVD is the same as the system control of the system control of the CD described above, and detailed explanation will be omitted.

The HD/BD light 2 emitted from the HD/BD laser 1 is transmitted through a beam forming component 3 and a diffraction grating 4 with an adjustable polarization switching function, and is divided into the HD light beam 6 and the BD light beam 7 by the polarizing beam splitter 5 according to a direction of polarization.

The HD light is reflected by the triangular prism 8, is transmitted through a lens 9 and the quarter wavelength player 10, is reflected by the composite type erecting prism 32, is transmitted through the lens 33 and the aperture limiting element 34, and enter the HD/DVD/CD compatible objective lens 13. Finally, it is focused on an HD disc 300.

After being reflected by the HD disc 300, the light beam is transmitted though the HD/DVD/CD compatible objective lens 13, the aperture limiting element 34, and the lens 33, and is reflected by the composite type erecting prism 32.

Then the light beam is transmitted through the quarter wavelength (λ/4) plate 10 and the lens 9, is reflected by the triangular prism 8, is reflected by the polarizing beam splitter 5, is transmitted through the detection lens 14, and enters the photodetector 15.

Using the signal obtained with the photodetector 15, at the time of HD reproduction, a HD reproduced signal is obtained, and the system shown in FIG. 6 controls the HD/DVD/CD compatible objective lens 13 so that a best optical characteristic may be attained by the objective lens 13 being subjected to focus control, tracking control, and tilt control.

On the other hand, the BD beam 7 is transmitted through the lens 16 and the quarter wavelength (λ/4) plate 10, is reflected by the mirror 11, and enters the objective lens 17 for BD. Then, the light beam is focused onto a BD disc 400.

After reflected by the BD disc 400, the light beam is transmitted through the objective lens 17 for BD, is reflected by the mirror 11, is transmitted through the quarter wavelength (λ/4) plate 10, the lens 16, the polarizing beam splitter 5, and the detection lens 14, and enters the photodetector 15.

Using the signal obtained with the photodetector 15, at the time of BD reproduction, a BD reproduced signal is obtained, and the system shown in FIG. 6 controls the HD/DVD/CD compatible objective lens 13 so that a best optical characteristic may be attained by the objective lens 13 being subjected to the focus control, the tracking control, and the tilt control.

Adopting the configuration described above makes it possible to manufacture an inexpensive and small-spaced optical pickup that supports four kinds of optical discs of the BD, the HD, the DVD, and the CD.

According to the embodiment described above, in the optical system that is equipped with the first objective lens (objective lens exclusively for the BD) the second objective lends (objective lens exclusively for HD, or an objective lens compatible with the HD, the DVD, and the CD), the laser light source, the photodetector, and the optical component for dividing the light beam into two beams for the two objective lenses and has the two optical system each for guiding the light beam to one of the objective lenses for the two kinds of optical discs, the BD and the HD, under mutually different standards that use the same wavelength for recording/reproduction; sharing of the laser light source and the photodetector can make the BD-side and HD-side optical systems inexpensive and small-spaced, and further a combination of the optical systems and the CD/DVD optical system has an excellent effect in capability of recording and reproducing four kinds of optical discs, i.e., the CD, the DVD, the first next generation DVD (BD), and the second next generation DVD (HD).

Moreover, the optical pickup apparatus described above is installed in the optical disc apparatus and used. The optical disc apparatus acquires a reproduced signal by performing signal processing on the signal obtained by the optical pickup apparatus, and reproduces information recorded in the information recording/reproduction medium that is being rotated by a rotation drive mechanism of a motor etc. Moreover, the optical disc apparatus can record information on various information recording/reproduction media, such the CD, the DVD, the BD, and the HDDVD, by irradiating a recording light beam from the optical pickup apparatus onto the information recording/reproduction media.

According to this invention, a small-sized optical pickup apparatus capable of either recording or reproducing two kinds of information recording/reproduction media mutually different in thickness of substrate that use a laser beam emitted from the identical light emitting device, and optical disc apparatus equipped therewith can be provided.

In the above, the optical pickup apparatus and the optical disc apparatus equipped therewith that accord to this invention were explained. However, this invention is not limited to the embodiments described above, but may include various modifications and variations.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. An optical pickup apparatus compatible with at least a first optical disc and a second optical disc having a recording surface or a reproduction surface, the second optical disc being different from the first optical disc in thickness of substrate, the optical pickup apparatus comprising:
a light emitting device,
a first objective lens for focusing a laser beam emitted from the light emitting device onto the first optical disc,
a second objective lens for focusing the laser beam emitted from the light emitting device onto the second optical disc,
a light receiving device for receiving the laser beam reflected by the first optical disc or the second optical disc, and
an optical system for dividing the laser beam emitted from the light emitting device into a beam for the first objective lens and a beam for the second objective lens, the optical system including a first optical component for reflecting or transmitting the laser beam according to the direction of polarization of the laser beam and a second optical component for transmitting the laser beam having been transmitted through the first optical component,
wherein the laser beam reflected by the first optical component is guided to the first objective lens, the laser beam reflected by the second optical component is guided to the second objective lens, the second optical component does not make contact with a mechanical component that is a fundamental constituent of the optical pickup apparatus.

2. The optical pickup apparatus according to claim 1,
wherein the second optical component has a reflecting member and a holder holding the reflecting member to adjust position or angle of the reflecting member to the mechanical component.

3. The optical pickup apparatus according to claim 1,
wherein the second optical component is either a reflection mirror or a reflection prism.

4. The optical pickup apparatus according to claim 1,
further comprising a third optical component between the second optical component and the second objective lens,
wherein the third optical component does not make contact with a mechanical component that is a fundamental constituent of the optical pickup apparatus.

5. The optical pickup apparatus according to claim 4,
wherein the third optical component is a lens held by a lens holder and the lens is set to the lens holder with intervening adhesive so as not to make contact with the lens holder.

6. The optical pickup apparatus according to claim 1,
wherein the light emitting device, the laser beam and the light receiving device is respectively defined as a first light emitting device, a first laser beam, and a first light receiving device,
the optical pickup apparatus further compatible with a third optical disc on which recording or reproduction is performed with a second laser beam whose wavelength is different from that of the first laser beam,
the optical pickup apparatus further comprising: a second light emitting device for emitting the second laser beam; and
a second light receiving device for receiving the second laser beam reflected by the third optical disc,
wherein the first or second objective lens focuses the second laser beam onto the third optical disc.

7. The optical pickup apparatus according to claim 6, further compatible with a fourth optical disc on which recording or reproduction is performed by a third laser beam whose wavelength is deferent from wavelength of the first and second laser beams, the optical pickup apparatus further comprising:
a third light emitting device for emitting the third laser beam, and
a third light emitting element for receiving the third laser beam reflected by the fourth optical disc,
wherein the first or second objective lens focuses the third laser beam onto the fourth optical disc.

8. An optical disc apparatus, comprising:
an optical pickup apparatus compatible with at least a first optical disc and a second optical disc having a recording surface or a reproduction surface, the second optical disc being different from the first optical disc in thickness of substrate; and
a signal processing unit for processing a signal from the optical pickup apparatus,
wherein the optical pickup apparatus comprises:
a light emitting device;
a first objective lens for focusing the laser beam emitted from the light emitting device onto the first optical disc;
a second objective lens for focusing the laser beam emitted from the light emitting device onto the second optical disc;
a light receiving device for receiving the laser beam reflected by the first optical disc or the second optical disc; and
an optical system for dividing the laser beam emitted from the light emitting device into a beam for the first objective lens and a beam for the second objective lens, the optical system including a first optical component for reflecting or transmitting the laser beam according to the direction of polarization of the laser beam and a second optical component for transmitting the laser beam having been transmitted through the first optical component,
wherein the laser beam reflected by the first optical component is guided to the first objective lens, the laser beam reflected by the second optical component is guided to the second objective lens, the second optical component does not make contact with a mechanical component that is a fundamental constituent of the optical pickup apparatus.

9. The optical disc apparatus according to claim 8,
wherein the second optical component has a reflecting member and a holder holding the reflecting member to adjust position or angle of the reflecting member to the mechanical component.

10. The optical disc apparatus according to claim 8,
wherein the second optical component is either a reflection mirror or a reflection prism.

11. The optical disc apparatus according to claim 8,
further comprising a third optical component between the second optical component and the second objective lens,
wherein the third optical component does not make contact with a mechanical component that is a fundamental constituent of the optical pickup.

12. The optical disc apparatus according to claim 11,
wherein the third optical component is a lens held by a lens holder and the lens is set to the lens holder with intervening adhesive so as not to make contact with the lens holder.

13. The optical disc apparatus according to claim 8,
wherein the light emitting device, the laser beam and the light receiving device is respectively defined as a first light emitting device, a first laser beam, and a first light receiving device,
the optical pickup apparatus further compatible with a third optical disc on which recording or reproduction is performed with a second laser beam whose wavelength is different from that of the first laser beam,
the optical pickup apparatus further comprising:
a second light emitting device for emitting the second laser beam; and
a second light receiving device for receiving the second laser beam reflected by the third optical disc,
wherein the first or second objective lens focuses the second laser beam onto the third optical disc.

14. The optical disc apparatus according to claim 13, further compatible with a fourth optical disc on which recording or reproduction is performed by a third laser beam whose wavelength is deferent from wavelength of the first and second laser beams, the optical pickup apparatus further comprising:
a third light emitting device for emitting the third laser beam; and
a third light emitting element for receiving the third laser beam reflected by the fourth optical disc,
wherein the first or second objective lens focuses the third laser beam onto the fourth optical disc.
